(19) United States
(12) Patent Application Publication
(10) Pub. No.: US 2005/0238539 A1
(43) Pub. Date: Oct. 27, 2005

(54) Apparatus for automated fresh tissue sectioning

(76) Inventors: Gal Shafirstein, Little Rock, AR (US); Scott L. Ferguson, Vilonia, AR (US); Louis M. Fink, Little Rock, AR (US); Paula E. North, Little Rock, AR (US); Milton Waner, New York, NY (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 10/816,016

(22) Filed: Apr. 1, 2004

(51) Int. Cl. B01L 3/00

(52) U.S. Cl. 422/99

(57) ABSTRACT

An apparatus for sectioning fresh unfixed tissue into very thin layers with preserved tissue architecture, antigenicity, mRNA content, and amenable to 3-D computer reconstruction. An electro-discharge machine (EDM) to accurately slice tissues through electro-dissociation of the tissue without mechanical or thermal damage. The tissue sample is placed on a holder submerged in a cooling bath comprising a liquid such as saline or water to minimize thermal effects and to provide a sink for dissociated ions. A cutting tool is electrically biased with respect to the tissue sample. A computer controlled EDM machine with x-y-z translation stage slices the tissue as defined by a predetermined program. The liquid in the cooling bath may be cooled to minimize tissue heating during cutting. In a preferred embodiment, the cutting tool may use focused RF energy to produce consecutive thin sections of fresh tissue for immunohistochemical and nucleic acids analyses by electro-dissociation without mechanical or thermal damage, ultimately allowing high-resolution volumetric reconstruction of gene and protein expression patterns of large tissue specimens.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to the automated sectioning of consecutive thin sections of fresh tissues by electro-dissociation without mechanical force or thermal damage to the tissue.

2. Brief Description of the Related Art

Routine histochemical analyses of thin tissue sections by light microscopy using chemical stains such as hematoxylin and eosin to highlight general nuclear and cytoplasmic features is the mainstay of surgical pathological diagnosis as well as morphological research. Another method, immunohistochemistry, provides more specific information about tissue sections by tagging a molecule of interest. Immunohistochemistry works on the principle of using an exogenous antibody raised against the molecule that is linked either to a fluorescent tag or to an enzyme that produces a local color reaction upon exposure to an appropriate chromagen. Immunohistochemistry allows phenotypic markers to be detected and interpreted within a morphologic context, making this methodology an essential tool in both diagnostic pathology and research.

The most widespread use of immunohistochemistry in pathology is to supplement morphologic criteria in determining the appropriate classification of neoplasms by revealing the expression of specific proteins or other antigens in these tissues. Recent advances in molecular biology now allow detection by light microscopy of specific DNA and mRNA sequences within tissues via in situ hybridization. Nucleic acids can also now be amplified in situ by polymerase chain reaction (PCR) prior to detection by hybridization. Laser capture microdissection methods using frozen tissue sections combined with ultra-sensitive linear amplification and reverse transcriptase PCR (RT-PCR) have allowed successful gene expression analyses on small numbers of cells of specific type or location selectively “plucked” from the tissue by a laser under light microscope guidance.

Unfortunately, traditional tissue fixation and processing prior to paraffin-embedding destroys many immunohistochemical target antigens and mRNA target sequences. This problem can in part be alleviated by the use of frozen, unfixed sections in which antigenic and nucleic acid targets are preserved. However, frozen sections are of poor histological quality due to ice-crystal artifacts, thus making them unsuitable for laser capture studies and 3-dimensional reconstruction of morphology or gene expression patterns.

Currently available tissue sectioning techniques employ either a rigid blade microtome or a vibratome. While the microtome cuts by forcing the tissue against a blade, the vibratome cuts with a sawing action as the oscillating blade pushes against the tissue. With both devices, the tissue can be cut at room temperature or cryogenic temperatures (e.g., −20° C.). (Kan, R., et al., Free-floating cryostat sections for immunoelectron microscopy: Bridging the gap from light to electron microscopy. Microsc Res Tech 54(4): 246-53 (2001); Kenny-Moynihan, M., et al., Immunohistochemical and in situ hydridization techniques, Advanced Diagnostic Methods in Pathology, (2002); Halbhuber, K., et al., Modern laser scanning microscopy in biology, biotechnology and medicine. Ann Anat 185(1): 1-20 (2003)).

Vibratome sectioning of frozen tissues is sometimes used in the research setting, but is not advantageous in the clinical setting. Sectioning of fresh tissues without freezing (and therefore without ice artifacts) requires either that the tissue be fixed and immobilized in paraffin, or cut with a vibratome. Unfortunately, the vibratome cannot produce sections of soft tissues that are thin enough for high resolution work (4-10 μm) without rigidifying the specimen by freezing or fixing prior to sectioning. The minimum thickness of vibratome sections of unfrozen, unfixed tissue is about 40 μm at room temperature and in practice 60-100 μm. (Sallee, C., et al., Embedding of neural tissue in agarose or glyoxyl agarose for vibratome sectioning. Biotech Histochem 68(6): 360-8 (1993); Stuart, D., et al., Embedding, sectioning, immunocytochemical and stereological methods that optimize research on the lesioned adult rat spinal cord. J Neurosci Methods 61(1-2): 5-14 (1995); Luchtel, D., et al., Histological methods to determine blood flow distribution with fluorescent microspheres. Biotech Histochem 73(6): 291-309 (1998); Ghosh, F., et al., Partial and full-thickness neuroretinal transplants. Exp Eye Res 68(1): 67-74 (1999); Kan, R., et al., Free-floating cryostat sections for immunoelectron microscopy: Bridging the gap from light to electron microscopy. Microsc Res Tech 54(4): 246-53 (2001); Halbhuber, K., et al., Modern laser scanning microscopy in biology, biotechnology and medicine. Ann Anat 185(1): 1-20 (2003)).

Frozen sectioning using a rigid microtome blade in a so-called “cryostat” is fast and can produce very thin sections. Frozen sectioning eliminates thermal and chemical damage to protein and nucleic acid structure, but is associated with ice crystal artifacts that obscure important histological features. Albeit distorted by ice artifacts, this is the routine method of tissue sectioning for intra-operative surgical pathology.

Since large hexagonal ice crystals that form within the tissue during freezing cause more major structural damage than small ice crystals, ice artifacts can be reduced by rapid cooling of the tissue. Ice crystal formation cannot in practice be eliminated, because the extreme cooling rates needed to produce solid amorphous ice, or vitreous ice, cannot be realistically achieved. (Dubochet, J., et al., Amorphous solid water produced by cryosectioning of crystalline ice at 113 K. J Microsc 207(Pt 2): 146-53 (2002)).

Since traditional mechanical tissue sectioning methodologies require rigidified specimens to produce thin sections, we have examined the possibility of sectioning soft tissue in their native, pliable state with electromagnetic energy. The effect of radio frequency (RF) power on biological tissues is an increase in kinetic energy of the absorbing molecules, thereby producing a general heating in the medium. The energy absorbed by the tissues produces a temperature rise that is dependent on the cooling mechanisms of the tissue. In air, where there is no forced cooling, as in electrosurgery, the affected thermal damaged area could be as large as 1.2 mm (Chinpairoj, S., et al., A comparison of monopolar electrosurgury to a new multipolar electrosurgical system in a rat model. Laryngoscope 111(2): 213-7 (2001)) and in some cases the zone of thermal necrosis could be 0.97-1.4 mm (Duffy, S, et al, In-vivo studies of uterine electrosurgery. Br J Obstet Gynaecol 99(7): 579-82 (1992); Duffy, S., The tissue and thermal effects of electosurgery in the uterine cavity. Ballieres Clin Obstet Gynaecol 9(2):261-77).

Research has shown that the collateral tissue damage in electrosurgery can be reduced by lowering the frequency to 0.1 MHz and introducing a liquid or gel between the electrode and the tissue. (Burns, R., et al., Electrosurgical skin resurfacing: a new bipolar instrument. Dermatol Surg 25(7): 582-6; Chinpairoj, S., et al., A comparison of monopolar electrosurgury to a new multipolar electrosurgical system in a rat model. Laryngoscope 111(2): 213-7 (2001)). When an electrically conductive fluid or gel is used in conjunction with RF, the ions transfer the energy to the tissue leading to breakage of covalent bonds of the structural proteins. If an external liquid is present at the interface of the tissue-probe, a large fraction of the thermal energy will be absorbed by the liquid or gel thus reducing the thermal damage in the tissue. In this process, sometimes referred to as electro-dissociation (Chinpairoj, S., et al., A comparison of monopolar electrosurgury to a new multipolar electrosurgical system in a rat model. Laryngoscope 111(2): 213-7 (2001)), the maximal temperature can be reduced to 70-100° C. and the region of thermal damage can be as low as 20-60 μm. Thus, by improving the heat transfer conditions even at room temperature the thermal damage in electrosurgery can be reduced by a factor of 20.

There exists a need in the art for the ability to observe gene expression patterns, as well as basic tissue morphology, at high-resolution in three dimensions within complex, large blocks of tissue. An electro-sectioning system for producing thin sections (4-10 μm) of fresh (unfixed, unfrozen) tissues of a high quality suitable for histological, immunohistochemical, and gene expression (mRNA) analyses is described herein.

### BRIEF SUMMARY OF THE INVENTION

The ability to observe gene expression patterns, as well as basic tissue morphology, at high-resolution in three dimensions within complex, large blocks of tissue is needed. Prior art methodologies produce tissue sections that are altered either in architecture by ice artifacts, in molecular integrity by fixation and processing, or are too thick for high-resolution imaging. The present invention is directed at a new technique that can section fresh unfixed tissue into very thin layers (4-10 microns) with preserved tissue architecture, antigenicity, and mRNA content, that is also amenable to 2-D or 3-D computer reconstruction that can be compared with MRI and CAT scans. Electro-dissociation, preferably using focused radio frequency (RF) energy, can produce consecutive thin sections of fresh tissue for immunohistochemical and nucleic acids analyses by electro-dissociation. The present invention describes an apparatus and method to section tissues without mechanical force or thermal damage, thus ultimately allowing high-resolution volumetric reconstruction of gene and protein expression patterns of large tissue specimens.

Conventional tissue preparation for sectioning includes the following steps: (1) The tissue is fixed in formalin followed by processing to preserve the tissue or the tissue is frozen at −70° C.; (2) The tissue is set in wax following formalin or kept frozen; (3) The block or frozen tissue is sliced (to 2-20 μm thick slices) by mechanical means using a microtome where the typical slice thickness is 2-5 μm; (4) The slices are mounted on an electrically charged microscope glass slide; and (5) The tissue slices are chemically and/or biologically processed to reveal/highlight specific details such as cells, vessels, proteins or any antigen. The two most time consuming portions of this process are steps 2 and 4. Conventionally, step 5 has been automated to improve the accuracy and speed of the process and eliminating the requirement for a skilled technician.

The present invention is designed to cut fresh tissue for histopathological and immunological examination, at room temperature, without prior processing. The tissue could be as large as a human body requiring a very large device or it could be a complete tumor or lesion for sectioning in a desktop system. The device could be applied to homogeneous tissue or heterogenous tissue (e.g., made of a combination of fat, muscle and bone). The sectioning process of the present invention could easily be automated, thereby eliminating the requirement of a skilled technician in step 2 above.

The device of the present invention is based on the concept of using an electro-discharge machine (EDM) to accurately slice tissues submerged in liquid, in order to minimize the thermal effects. The device is a modification of an “electric knife” routinely used in surgery to remove tissue. The present invention would use similar technology modified to minimize thermal damage to the tissue. In operation, the tissue removed from a patient would be placed on a holder submerged in a cooling bath comprising a liquid such as saline or water. A computer controlled EDM machine with x-y-z translation stage would slice the tissue as defined by a predetermined program. The liquid in the cooling bath could be cooled to minimize tissue heating during cutting.

This device would enable a greater degree of flexibility in cutting geometry, in both thickness and surface area. Furthermore, since the cuffing mechanism is through a local strong electric field that results in electrochemical etching of the tissue, we should be able to cut inhomogeneous tissues of different hardness (e.g., collagen and fat, bone and muscle, etc.) with the same instrument.

These devices could be used to make serial sections of a complete tumor or lesion that could be stained and reconstructed on a computer to provide a virtual 3-D histological image of the lesion as it was positioned in the body. By automating the slice cutting procedure and doing it in liquid with EDM we minimize distortion of the slices since the cutting is done through electro-erosion or electro-dissociation of the tissue with no physical force on the tissue. This procedure will allow the physician to visualize the tumor in the patient body and accurately assess whether the complete tumor was removed. Furthermore, it will provide a superb resolution, at a cellular level, to view the microstructure of the tissue with reference to its location in the body. The device will enable thin sections (e.g., 2-10 μm thick) to be cut in fresh, large and inhomogeneous tissues (e.g. fat and muscles) that do not have to be previously processed and embedded in paraffin. The present inventors are aware of no other technique that allows this at the present time.

The present invention solves the following problems:

(1) Eliminate the damage caused by preprocessing of the tissue (e.g., freezing or embedding it in paraffin) required for preparing the thin tissue slice, thus allowing routine staining to be performed on an unprocessed thin slice. The staining is an absolute requirement for histopathological analysis. While ultrasound cutting can also allow cutting unprocessed tissues, the slices are too thick; i.e., a minimum of 100-200 μm.

(2) Speed up the process of analyzing samples taken from lesions removed during or immediately after surgery, allowing slices of fresh tissue to be stained in less than an hour. At present this can only be done with frozen tissue, but freezing may damage the tissue, and frozen tissues cutting can only be done on relatively small and soft tissue samples (e.g., 4-10 mm cross section)—these samples could well be non-representative of the lesion they were taken from. The present invention will allow slicing of large and even hard tissues that are much more representative of the tissue they were taken from.

(3) Allow serial slices from lesions to be obtained that can be used for 2-D and 3-D reconstructions. The current technique (microtome) allows serial cutting, but the size of the slice is limited in dimensions less than one square inch and the tissue must embedded in paraffin that has to be place in a water bath and thus will be randomly located on a microscopic slide. Moreover the microtome process is very laborious and is not automated. Automation of this process would likely require expensive robotic systems (as it is almost random), and would suffer from size limitations and all other issues that associated with using a microtome (e.g., inconsistency of slice thickness, missing slices, and inability to cut hard and soft tissues in the same specimen). The microtome was not designed for that purpose as it is routinely used to obtain a single or few slices from a specimen.

Among the advantages of the present invention is virtual reconstruction of the lesion as it was within the patient before surgery. The stained lesion slices may be reconstructed to a 2-D or 3-D object which represents the lesion as it was removed from the patient. This image may then be incorporated with a MRI image to show how the lesion was located within the patient before surgery. This capability is extremely important to determine if the abnormal tissue was indeed removed in its entirety (for malignant lesions) and to understand the growth mechanisms of all type of lesions (such as vascular lesions). To achieve that goal the lesion needs to be removed as one or two to three pieces at most. To virtually “place” the stained tissue within the patient, inert markers (such a graphite) that can be easily distinguished and imaged by MRI, ultrasound and CT may be placed presurgically within the lesion. These markers remain unchanged in the 2-D or 3-D reconstruction and may be used for locating the virtual stained tissue within the patient.

Using surface immunostaining techniques including iron or copper the tissue surface could be imaged before cutting and that image could be used for the reconstruction and examination of the lesion. In this case the imaging could be done with a spectrophotometer and/or lasers and high resolution digital cameras to obtain a histopathology-like micrograph.

It is therefore an object of the present invention to provide for a device and method capable of producing ultra-thin sections of large, unfixed tissue specimens.

It is a further object of the present invention to provide for a device and method of producing ultra-thin sections of large, unfixed tissue specimens with preserved tissue architecture, antigenicity and mRNA content.

It is a further object of the present invention to provide for a device and method of producing ultra-thin sections of large, unfixed tissue specimens that are amenable to 2-D and 3-D molecular analysis.

It is a further object of the present invention to provide for an alternative device and method to intraoperative frozen section diagnosis.

It is also an object of the present invention to provide for a device and method for sectioning of fresh, unprocessed specimens of large size, thus allowing rapid intra-operative evaluation of the surgical margins of an entire resected tumor specimen, without the need for regional sampling.

It is also an object of the present invention to provide for a device and method for sectioning of fresh, unprocessed specimens of large size without compromising the sections by ice artifacts.

### BRIEF DESCRIPTION OF THE DRAWINGS

These and other features, objects and advantages of the present invention will become better understood from a consideration of the following detailed description and accompanying drawings in which:

FIG. 1A shows a cross-sectional elevation view of an embodiment of the present invention in which the cutting tool is a blade having a multi-layered structure.

FIG. 1B is a partial elevation view of the tissue sample on the tissue holder of the present invention.

FIG. 1C is a plan view of an embodiment of the invention where the cutting tool is a taut thin wire.

FIG. 2 shows an elevation view of the device of the present invention.

### DETAILED DESCRIPTION OF THE INVENTION

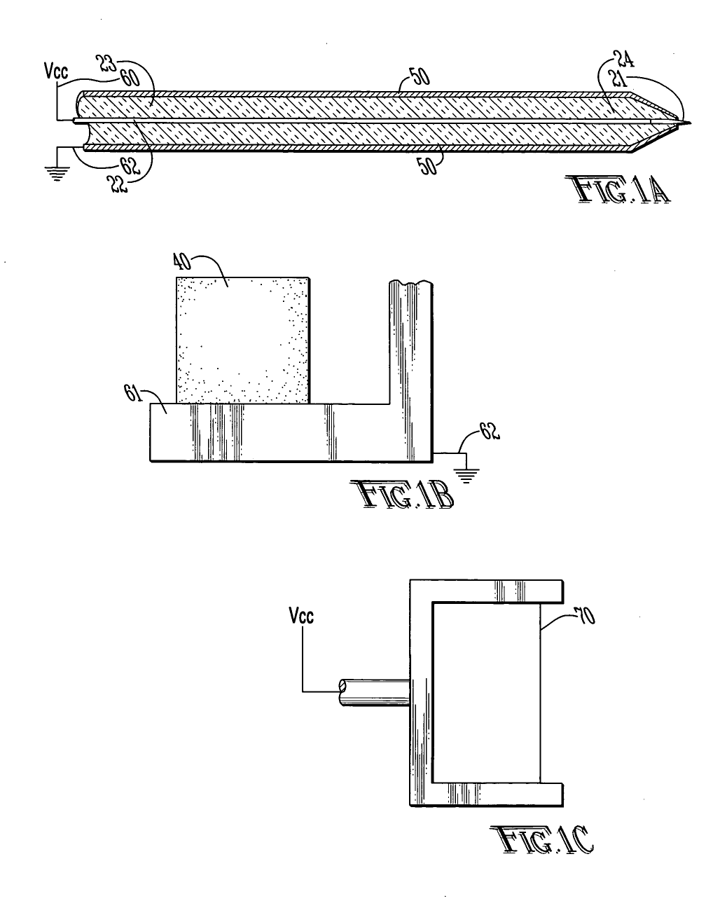

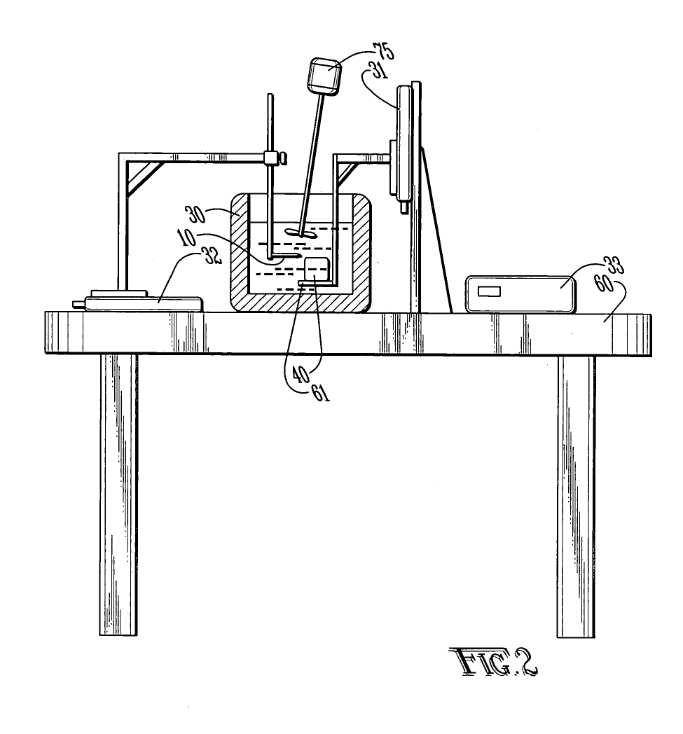

With reference to FIGS. 1A-C and 2, the preferred embodiments of the present invention may be described. The present invention is directed to satisfying the need to produce thin (4-10 μm) serial sections of large fresh tissue specimens that are suitable for high-resolution in situ protein/gene expression studies without ice artifacts or fixation-induced molecular damage.

Limitations of the existing sectioning techniques result from the fact that they rely on mechanical cutting, which in turn requires the tissue to be rigid. The present invention is a new approach to section tissue via an electro-dissociation process. The cutting tool is electrically biased with respect to the tissue sample which is submerged in a cooling bath. In one embodiment, the cutting tool may use focused radio frequency (RF) energy. The concept of electro-dissociation is known in devices known as electro-discharge machines (EDM) which are used to cut metals. Similar devices using this principle are known as “electric knives” that are routinely used in surgery. The present invention is directed to a method of using electro-dissociation to produce consecutive thin sections of fresh tissue for immunohistochemical and nucleic acids analyses without mechanical or thermal damage, ultimately allowing high-resolution reconstruction of gene and protein expression patterns of large tissue specimens. Since the method and apparatus of the present invention uses electro-dissociation rather than ablation to section tissue, thermal damage is minimized.

Sectioning without mechanical pressure minimizes deformation of soft tissue specimens that are held in position during the sectioning procedure. Therefore, the present invention is directed at using an electric field to cut tissue samples. The electric field will be directed using a cutting tool 10 where the electric field is preferably highly focused at the cutting edge, although some applications may permit a lower degree of focusing. Focusing of the electric field is accomplished by using a cutting tool 10 with a thin structure such that the energy is concentrated on a thin edge, e.g., a taut small diameter wire 70, or by using a blade 20 in which the electric field is focused at the edge 21 of the blade 20. As shown in FIG. 1C, the wire 70 is preferably small in diameter to produce a narrowly focused field. A suitable diameter would be around 0.2 mm, although the invention is not limited to this wire size. The multi-layered structure of the blade 20 as described below also serves to focus the electric field at the narrow leading edge of the blade 20. The electric field will reach its maximum intensity at the tissue-blade interface, dissipating very rapidly away from this interface. However, as previously described, RF energy can cause thermal damage to the tissue. To eliminate heating or thermal damage, the tissue will be cooled without freezing by submerging it during the cutting process in a liquid cooling bath 30 containing cryoprotectants as necessary. If the temperature of the cooling bath is 0° C. or below, cryoprotectants would be required; otherwise, if the temperature is above 0° C., cryoprotectants are not required. The cooling bath 30 may be cooled by any of a variety of refrigeration means (not shown) that would be apparent to one of ordinary skill in the art. Further, the cooling bath 30 may include a stirring apparatus 75 to stir the cooling liquid to dissipate both heat and dissociated molecular components from the tissue in the vicinity of the cutting tool 10. The cooling bath 30 provides a relatively large “sink” to accept dissociated ions from the tissue sample 40 and to avoid the buildup of a high gradient of dissociated ions in the vicinity of the cutting tool 10 and tissue sample 40. The cooling bath 30 may comprise any of various liquids, such as a water, saline, buffered saline, silicone oil, etc. The liquid may be either an electrolyte or a non-electrolyte.

The field of cut will be confined to a very narrow region (a few microns) by delivering the energy to the tissue via a thin wire or a very fine multi-layered blade 20. The multi-layered blade 20 can be produced using thin film technologies such as physical or chemical vapor deposition. In one version of the invention, the tissue sample 40, either directly or through the tissue holder 61, is connected to a return electrode as shown in FIG. 1B. More generally, the cutting tool 10 must be biased electrically with respect to the tissue 40. Although RF is the preferred form of electrical field for providing the electro-dissociation of the tissue 40, the field associated with the cutting tool 10 may be AC or DC and the frequency is not limited specifically to RF. As the blade 20 is passed through the tissue specimen, molecular bonds in the tissue will be “electro-dissociated,” so that the release of dissociated ions will create a sharp, defined plane of section. In electro-dissociation, individual ions are separated from the bulk of the tissue sample without putting mechanical stress on the tissue. Electro-dissociation allows harder tissues such as bone to be sectioned easily, unlike prior art methods that require significantly greater mechanical force to section bone than more easily sectioned tissues such as fat and muscle.

Active cooling of the liquid cooling bath 30 and precise focusing of the electric field at the edge 21 of the wire or blade 20 will minimize thermal damage to the tissue. For example, the electric field could be an electromagnetic field and the frequency could include 100 khz with the current density less than 0.1 A/cm² where tissue temperature will not exceed 38° C. during the process. By combining these two techniques of cooling the tissue in a cooling bath and narrowly focusing the electric field, tissue can be cut by electro-dissociation while eliminating thermal damage and limiting the energy absorption to a submicron region. This will allow consecutive production of ultra-thin (4-10 μm) tissue sections that can be captured on glass slides for histological, immunohistochemical, and nucleic acid analysis.

One embodiment of the present invention would drag a very thin, taunt wire 70 carrying current, e.g., RF current, through the cooled tissue in an X, Y plane, producing a thin plane of tissue electro-dissociation in the path of the wire 70. The plane of the motion of the wire 70 will be positioned precisely parallel to a positively charged glass slide (not shown) positioned on the surface of the tissue specimen 40. Thus the released section, being negatively charged, will stick to the slide, and the slide containing the sliced section will be pulled mechanically away from the tissue specimen 40 and retrieved for staining and analysis. Another slide would then be positioned on the surface of the tissue specimen 40 and the process repeated.

The relative positions of the glass slide and wire in X, Y, and Z axes is precisely controlled by a motorized linear translation stage and appropriate fixed supports. For example, and not by way of limitation, a vertical translation stage 31 may be used to move the tissue specimen 40 in a vertical or Z axis direction, while a horizontal translation stage 32 may be used to move the cutting tool 10 in a horizontal plane including the X and Y axes. The motion of the vertical and horizontal translation stages 31, 32 are under the direction of a computerized motion controller 33. Variables related to the slide include the amount of pressure applied to the slide against the tissue specimen 40 in order to achieve adhesion without distortion, the type of positively charged coating on the slide, or use of a conductive metal “slide” followed by transfer of the section to glass for microscopy.

Another embodiment of the present invention uses thin film technology to produce a rigid blade 20 that will pass through the specimen 40, cutting by electro-dissociation at its leading edge 21 where the electrical field, e.g. RF energy, is to be focused as shown in FIG. 1A. The leading edge 21 is electrically connected to an electrode 22 and may be made from a stainless steel or titanium razor blade. The blade 20 may be formed by masking the edge 21 of the blade 20 to prevent deposition of metallic and insulator layers at the edge 21. This central electrode 22 is then coated with a sandwich of insulator 23 such as benzocyclobutene (BCB) at 5 to 10 microns in thickness on each side of the electrode 22 followed by a biocompatible electrically-conductive alloy 50 such as platinum/silver alloy. In operation, the electrically-conductive alloy 50 is electrically connected to ground and serves to focus the field on the edge 21. The final step of forming the blade 20 is to selectively etch the insulator 23 into a cutting shape 24 at the leading edge 21 of the blade 20 using a laser or electron beam in a high vacuum system.

The coatings 23, 50 will terminate about 200 μm from the edge 21, exposing the sharp metal of the electrode 22 to the solution, where the electric field 60 will be transmitted to the liquid medium of the cooling bath 30 and the tissue specimen 40. This will result in focusing the electric field 60 at a very narrow region between the edge 21 of the blade 20 and the tissue specimen 40. There will be no direct physical contact between the sharp edge 21 and the tissue specimen 40 as the blade 20 passes through the specimen 40 since the molecules of the tissue specimen 40 will be electro-dissociated as the tissue specimen 40 is approached by the edge 21 of the blade 20 generating a focused electric field, although the tissue may touch the upper or lower part of the blade. Through proper materials selection and blade design it is anticipated that the electric field may be focused to a few micrometers at its thin edge 21.

The geometry of the blade 20 is designed specifically to focus the electric field 60 while providing a rigid, thermally conductive surface 50 that can be used to lift up the tissue section after sectioning and help to extract any heat generated from it. As the blade 20 passes through the tissue specimen 40, a well-defined region of arc will be created between the blade 20 and the tissue specimen 40, which will lead to electro-dissociation of the tissue and flow of ions from the tissue to the solution in the cooling bath 30. In the preferred embodiment, the electric field is an RF field.

As with the embodiment of the moving wire, the motion of the electric field 60 will create a plane of tissue dissociation causing release of a fine layer of tissue (a “section”) from the bulk of the tissue specimen 40. The thickness of the section will be controlled, as with the wire method, by control of the position of the blade 20 relative to the surface of the tissue specimen 40 in the Z-axis during successive passes of the blade 20. Only the external metallic coatings 50 on the flat sides of the blade 20 will be in contact with the tissue as the blade 20 moves forward. There will be no physical contact between the sharp edge 21 and the tissue specimen 40, since the cutting mechanism is not mechanical, but rather based on electro-dissociation. The stiffness of the blade 20 will ensure a smooth plane of electro-dissociation as well and allow lifting up of the section onto the flat surface of the blade 20 after sectioning.

The power supply for the cutting system could include a signal generator and broadband amplifier (not shown). The input energy is desirably obtained from a RF generator capable of delivering 300 watts of power. The frequency could be varied in the range of 10 kHz to 15 MHz. To achieve this a synthesized function generator (Stanford Research Inc., Sunnyvale, Calif.) and a broadband power amplifier (M404E RF power amplifier, Bell Electronics NW, Inc. Renton, Wash.) are anticipated to function acceptably. It is well known that frequencies in the 100 kHz range have been found to cause minimal damage in prior studies on electrosurgery. (Burns, R., et al., Electrosurgical skin resurfacing: a new bipolar instrument. Dermatol Surg 25(7): 582-6; Chinpairoj, S., et al., A comparison of monopolar electrosurgury to a new multipolar electrosurgical system in a rat model. Laryngoscope 111(2): 213-7 (2001)). As an example, other frequencies, such as the 490 kHz region which is easily obtained using available electro-surgical devices, may be used.

To achieve precise cutting and positioning, linear translation stages (M-ILS250CC and M-ILS250CCHA) available from Newport Corp, Irvine, Calif. are anticipated to perform acceptably in conjunction with a flexible digital controller (Newport, ESP7000-opt-02-01-nn-nn-n-01-n) available from Newport Corp, Irvine, Calif. The vertical translation stage 31 will adjust the height of the tissue specimen 40 relative to the cutting tool 10, either the taut wire 70 or the blade 20, thereby controlling slice thickness. A DC motor driven stage incorporating linear encoders or a micro-stepped motor driven stage will offer specifications suitable for this application.

The horizontal translation stage 32 may be used to actuate the cutting tool 10. A DC motor driven stage is desirably capable of providing a constant travel velocity. The velocity of the stage will need to be variable and capable of relatively rapid motion. A rotary encoder available from Newport, M-ILS250CC, would be acceptable for feedback control since absolute position will not be critical along the horizontal plane. The control electronics should be selected to fulfill the following four requirements: stage compatibility, stand alone point to point control, expandable and programmable for future automation requirements.

The translation stages 32, 31 are desirably mounted to an optical breadboard table 60 of the type available from Newport Corp., Irvine Calif. (VH3048W-OPT-25-NN-NN-NN-01-N-N-N-N-N-N-N) or a similarly rigid and easily used surface for stage mounting flexibility.

The tissue specimen 40 is desirably held in place by with a room temperature histomer such as that available from Histotech, Egaa, Denmark. The histomer is a room temperature polymerized agar base polymer that has been used to align tissue for cutting, without penetrating it (Bjarkam, Pedersen et al. 2001). Alternatively, the tissue specimen 40 can be floated with one face attached to a stage. As a further alternative, the tissue specimen 40 may be held in place by a polymer bag which is shrunk onto it so that the polymer bag becomes rigid at the operating temperature of the apparatus through the glass transition phase of the polymer with no heat involved. The tissue 40 is desirably submerged within a buffered isotonic saline cooling bath 30 at pH 7.4 and containing 10-30% glycerol at 2 C. The tissue specimen 40 is placed on a tissue holder 61 that in turn is connected to the return electrode 61. The temperature of the cooling bath 30 is desirably 2±1° C.

1. An apparatus for automated sectioning of a tissue specimen, comprising:
a cutting tool electrically biased with respect to the tissue specimen;
a tissue holder having means for holding the tissue specimen on said tissue holder;
a cooling bath containing a cooling liquid for submerging the tissue specimen during sectioning; and
means for moving said cutting tool whereby said cutting tool passes through the tissue specimen in a selected plane so as to separate sections of tissue from the tissue specimen by electro-dissociation.

2. The apparatus of claim 1, wherein said means for moving said cutting tool comprises a horizontal translation stage for moving said cutting tool in a horizontal plane, a vertical translation stage for moving the tissue specimen in a vertical direction, and computer means for controlling the motion of the horizontal translation stage and the vertical translation stage.

3. The apparatus of claim 1, wherein said cutting tool is a wire.

4. The apparatus of claim 1, wherein said cutting tool is a multi-layered blade.

5. The apparatus of claim 4, wherein said multi-layered blade comprises a central electrode having a leading edge, a layer of insulating material covering said central electrode except for said leading edge, said layer of insulating material formed into a cutting shape adjacent to said leading edge, and a layer of thermally and electrically conductive material covering said insulating material except adjacent to said leading edge.

6. The apparatus of claim 1 further comprising means for stirring said cooling liquid in said cooling bath.

7. An apparatus for automated sectioning of a tissue specimen, comprising:
a cutting tool operatively connected to a radio frequency (RF) generator;
a tissue holder having means for holding the tissue specimen on said tissue holder, said tissue holder being operatively connected to said RF generator;
a cooling bath containing a cooling liquid for submerging the tissue sampling during sectioning; and
means for moving said cutting tool whereby said cutting tool passes through the tissue specimen in a selected plane so as to separate sections of tissue from the tissue specimen by electro-dissociation.

8. The apparatus of claim 7, wherein said means for moving said cutting tool comprises a horizontal translation stage for moving said cutting tool in a horizontal plane, a vertical translation stage for moving the tissue specimen in a vertical direction, and computer means for controlling the motion of the horizontal translation stage and the vertical translation stage.

9. The apparatus of claim 7, wherein said cutting tool is a wire.

10. The apparatus of claim 7, wherein said cutting tool is a multi-layered blade.

11. The apparatus of claim 10, wherein said multi-layered blade comprises a central electrode having a leading edge, a layer of insulating material covering said central electrode except for said leading edge, said layer of insulating material formed into a cutting shape adjacent to said leading edge, and a layer of thermally and electrically conductive material covering said insulating material except adjacent to said leading edge.

12. The apparatus of claim 8 further comprising means for stirring said cooling liquid in said cooling bath.

13. A method of separating a tissue section from a tissue sample by electro-dissociation, comprising the steps of:
(a) providing a cutter biased electrically with respect to the tissue sample;
(b) submerging the tissue sample in a cooling bath comprising a cooling liquid; and
(c) passing said cutter through the bulk tissue sample in a defined plane to separate a tissue section from the tissue sample by electro-dissociation.

14. The method of claim 13 further comprising the step of stirring said cooling liquid in said cooling bath.
